(19) United States
(12) Patent Application Publication
(10) Pub. No.: US 2026/0141561 A1
(43) Pub. Date: May 21, 2026

(54) OBJECT DETECTION

(71) Applicant: ObjectVideo Labs, LLC, Tysons, VA (US)

(72) Inventors: Francesco Brughi, Barcelona (ES); Gemma Alaix I Granell, Barcelona (ES); Mashia Naushin Mazumder, Arlington, VA (US); Allison Beach, Leesburg, VA (US); Gang Qian, McLean, VA (US); Arnau Roche López, Cervelló (ES)

(21) Appl. No.: 19/389,616

(22) Filed: Nov. 14, 2025

Related U.S. Application Data
(60) Provisional application No. 63/722,121, filed on Nov. 19, 2024.

(51) Int. Cl. G06T 7/73; G06V 10/764; G06V 40/10

(52) U.S. Cl. CPC G06T 7/75; G06V 10/764; G06V 40/10; G06T 2207/20081; G06T 2207/30196

(57) ABSTRACT

Methods, systems, and apparatus, including computer programs encoded on computer storage media, for weapon object detection and classification and pose aggression analysis. One of the methods includes generating, for an image that depicts a person, a mapped pose model for the person that represents a pose of the person; predicting a first likelihood that the person is holding a weapon using at least some data from the mapped pose model and at least some data from the image; determining, from a plurality of pose types, a pose type for the person using the mapped pose model; determining an action to perform for the person using the first likelihood that the person is holding a weapon and the pose type for the person; and transmitting instructions to cause a device to perform the action.

### CROSS-REFERENCE TO RELATED APPLICATION

This application claims the benefit of U.S. Provisional Application No. 63/722,121, filed Nov. 19, 2024, the contents of which are incorporated by reference herein.

### BACKGROUND

Detection of firearm and firearm-related situations is important to public safety. Detection of such situations in an accurate manner and in real-time can be a challenging computational task.

### SUMMARY

In general, one innovative aspect of the subject matter described in this specification can be embodied in methods that include the actions of generating, for an image that depicts a person, a mapped pose model for the person that represents a pose of the person. The computer-implemented method includes predicting a first likelihood that the person is holding a weapon using at least some data from the mapped pose model and at least some data from the image. The computer-implemented method includes determining, from a plurality of pose types, a pose type for the person using the mapped pose model. The computer-implemented method includes determining an action to perform for the person using the first likelihood that the person is holding a weapon and the pose type for the person. The computer-implemented method includes and transmitting instructions to cause a device to perform the action.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. The mapped pose model may include three or more key points for the person; and predicting the first likelihood that the person is holding a weapon may use one or more of a first point for a first hand of the person or a second point for a second hand of the person. Predicting the first likelihood that the person is holding a weapon may include generating a heat map that indicates a likelihood that an object other than the person is depicted in a region of the image that includes at least a portion of the person using the data from the mapped pose model; and predicting the first likelihood using a classifier that classifies whether the person is holding a weapon using the heat map. Predicting the first likelihood using the classifier that classifies whether the person is holding a weapon may include computing, for at least one category of a plurality of categories and using the classifier, a corresponding confidence score that the weapon is of the corresponding category, the confidence score in one or more confidence scores each of which is for a corresponding category from the plurality of categories; determining, using the one or more confidence scores, whether a confidence criterion is satisfied; and determining the first likelihood using a confidence score from the one or more confidence scores that satisfies the confidence criterion. Predicting the first likelihood may use a pre-trained weapon detection model trained i) on at least one training image that depicts an object and ii) using an input value, from a plurality of input values, that indicated a) a size of the object and b) an input value, from the plurality of input values, that the weapon detection model used to limit a region of the image for analysis of the object. The object may be a hand-held object. The method may include predicting a second likelihood that the person is holding a hand-held object using at least some data from the mapped pose model and at least some data from the image; and determining the threatening pose probability value may include determining a threatening pose probability value using one or more of the mapped pose model, the first likelihood that the person is holding the weapon, or the second likelihood that the person is holding the hand-held object. Determining the threatening pose probability value may include determining a threatening pose probability value using the hand-held object confidence score. The plurality of hand-held object categories may include at least a non-weapon category, and in response to determining that the hand-held object confidence score is of the non-weapon category, determining the threatening pose probability value using the hand-held object confidence score of the non-weapon category. Detecting the pose type may include determining a threatening pose probability value using the mapped pose model; and determining the pose type using the threatening pose probability value. Determining the action may use the threatening pose probability value and the pose type; and transmitting the instructions may include transmitting the instructions to cause the device to perform the action determined using the threatening pose probability value and the pose type. Determining the pose type may include determining whether the threatening pose probability value satisfies a threatening pose threshold value, and in response to determining that the threatening pose probability value satisfies the threatening pose threshold value, selecting a threatening pose type. Determining the threatening pose probability value may include determining a threatening pose probability value using the mapped pose model and the first likelihood that the person is holding the weapon. The plurality of pose types may include a threatening pose type or a neutral pose type. The method may include determining, for an area in which the image that depicts the person was taken, an expected state of the area; determining, using the expected state of the area and the first likelihood that the person is holding a weapon, whether the person is expected to be holding the weapon; and determining, in response to determining that the person is expected to be holding the weapon, to not transmit the instructions. The method may include generating, for a second, different image that depicts the person, a second, different mapped pose model for the person that represents a second pose of the person in the second, different image; predicting a second likelihood that the person is holding the weapon using at least some data from the second, different mapped pose model and at least some data from the second, different image; determining, from the plurality of pose types, a second pose type for the person using the second, different mapped pose model, and updating, in response to determining the second pose type for the person is different than the pose type, the pose type to the second pose type. Transmitting, in response to determining the second pose type is different than the pose type, instructions to cause the device to perform the action may include, determining whether to transmit second instructions to cause the device to perform a new action using the second pose type.

In general, one innovative aspect of the subject matter described in this specification can be embodied in one or more computer storage media encoded with instructions that, when executed by one or more computers, cause the one or more computers to perform the method of any preceding claim.

In general, one innovative aspect of the subject matter described in this specification can be embodied in a system including one or more computers and one or more storage devices on which are stored instructions that are operable, when executed by the one or more computers, to cause the one or more computers to perform the methods described herein.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages.

The systems described herein monitoring an environment may beneficially increase the safety of persons within the environment. The system detects one or more person handling a weapon with a threatening pose by continuously monitoring the environment. The system automatically triggers one or more actions in response to the detection. The system may trigger actions more rapidly than if a person were responsible for monitoring the same environment.

The systems described herein may rapidly identify persons holding weapons and an associated pose type. The system may achieve this rapid identification by reducing the overall data being processed. The system processes received images using pre-trained key point mapping engines to direct downstream object identification engines to areas of interest. The system directing the object identification engines to areas of interest may reduce overall false positive weapon identifications. The system directing the object identification engines to areas of interest may increase the hand-held object identification accuracy.

The systems herein store a list of connected devices and at least one action associated with each connected device. The system determines an action to perform in response to the presence of a hand-held weapon and a pose type of a detected person. The system storing the list of connected device and associated actions may decrease the action response time after detecting the person, identifying the hand-held weapon, and an aggressive pose. The system decreasing the action response time may beneficially increase the safety of the environment in which the system operates.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A illustrates an example of the threat identification system including a threat analysis engine.

FIG. 1B illustrates an example pose model including seventeen key points.

FIG. 2 is a block diagram showing an example environment that includes the hand-held object detection engine of FIG. 1A.

FIG. 3 is a block diagram showing an example environment that includes the pose identification engine of FIG. 1A.

FIG. 4 is a flow diagram of a process for monitoring an environment for a person holding a weapon using a pose.

FIG. 5 is a diagram illustrating an example of a property monitoring system.

Like reference numbers and designations in the various drawings indicate like elements.

### DETAILED DESCRIPTION

In some environments, determining a pose of a person holding a firearm in real time using a video stream can be advantageous, such as a shooting range in which users are permitted to handle firearms only during certain times. In ‘hot’ times, users of a shooting range are permitted to handle firearms. Handling of firearms during ‘cold’ times in which such actions are not permitted can result in a violation of the safety of the environment. Shooting ranges are commonly monitored during business hours by video capture devices, thus, determining the pose of a person and presence of a firearm during ‘hot’ or ‘cold’ times using images generated by such devices can beneficially increase safety of the environment.

A system can determine a pose of a person, whether the person is holding a firearm, and an action to perform in response to such information. In some examples, a video capture device is arranged to produce images of the shooting range. The system receives the images and uses a pose identification engine to analyze the images. The pose identification engine generates a pose model including multiple key points using the images. The key points include body key points indicating the position of major body joints and object key points indicating predicted locations of hand-held objects. Although some of the examples described here refer specifically to firearms, similar types of operations can be performed for other types of hand-held firearms.

The pose identification engine analyzes the object key points to determine a heat map indicating the probability of a hand-held object. As used herein, hand-held describes situations in which the person is holding an object in one hand, different objects in each hand, or one object in both hands. The pose identification engine analyzes the body key points to determine a pose type. Some examples of pose types which can be determined include a neutral pose, a threatening pose, a defensive pose, or some combination of poses, e.g., threatening and defensive.

The hand-held object identification engine receives the pose type and the heat map of the object from the pose identification engine. The object identification engine processes the heat map of the object to determine whether a hand-held object is likely present and determines object features to generate an object classification, e.g., whether the object is a firearm, or a firearm type.

The system receives the object classification and the pose type and uses an alert generation engine to determine an action to perform using the object classification and pose type. For example, if the object classification is a firearm, the pose type is a threatening pose, and the shooting range state is cold, the system can determine to present a notification to the person that handling of firearms is not permitted, trigger an automated action in the building, e.g., maintaining a door to the end of the range near a target line in a locked position, or perform another appropriate action.

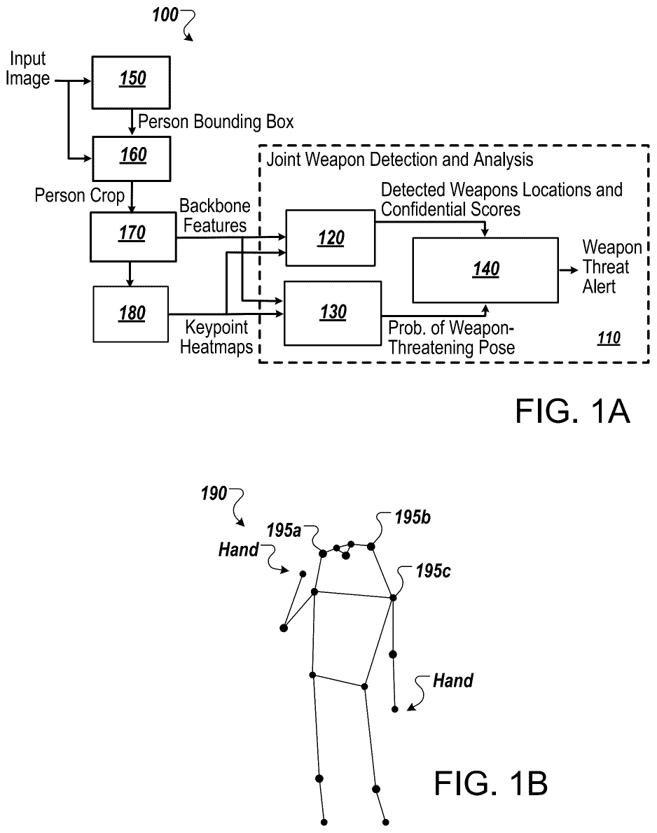

FIG. 1A illustrates an example of the threat identification system 100 including a threat analysis engine 110. A device can use the threat identification system 100 to monitor an environment for a person holding an object in their hands, identify the object as a firearm, and determine whether the person holding the identified firearm is using a threatening pose. The threat identification system 100 determines an action to perform using the identified information and the environment for which the threat identification system 100 is operating. For instance, the action that a threat identification system 100 determines to perform may be different for a shooting range as compared to a firearm store. The threat identification system 100 transmits instructions in response to the determined action, such as transmitting instructions to a magnetically locking door to lock, or unlock, in response to the determined action. Although some examples described in this specification relate to firearms, the systems and methods described in this specification can relate generally to any appropriate type of weapon, e.g., hand-held weapon.

The threat identification system 100 receives input images, or data representing input images, to be processed. The threat identification system 100 provides the received data to an object detector engine 150, an image cropping engine 160, or any combination of these. In some embodiments, the threat identification system 100 receives a representation of an image, such as a feature vector.

The object detector engine 150 detects a person depicted in the image. The object detector engine 150 can be a pre-trained object classification model, such as a computer vision model, trained to detect people depicted in images. The object detector engine 150 determines a bounding box for the detected person. The bounding box is a sequence of coordinates or other data defining a region of the image within which the detected person is, e.g., substantially, located. In some examples, the sequences of coordinates can define a rectangular bounding box enclosing the detected person. The object detector engine 150 provides the bounding box to the image cropping engine 160.

The image cropping engine 160 receives the bounding box from the object detector engine 150 and the image data from the threat identification system 100. The image cropping engine 160 crops the image using the bounding box enclosing the detected person and produces an image which contains the detected person. In general, cropping refers to discarding or otherwise not using image information outside of a region of interest of an image. In this case, the image cropping engine 160 discards the image information that is outside the bounding box. The image cropping engine 160 enlarges the bounding box by an amount, e.g., a fixed amount, or a scaled amount. In some examples, the amount the image cropping engine 160 enlarges the bounding box uses a fixed scaling factor. The image cropping engine 160 resizes the image to the scaled bounding box size. This reduces the quantity of information provided to downstream processing engines and can increase the processing speed of the threat identification system 100. In examples in which the threat identification system 100 receives a feature vector, the image cropping engine 160 crops data from the feature vector rather than image information.

The threat identification system 100 provides the image data to a pose estimator engine 170. The pose estimator engine 170 can be a pretrained pose estimator model. A pose estimator model is a computer vision machine-learning model that detects the position and orientation of a person within an image. The pose estimator model predicts the location of specific key points like hands, head, elbows, etc. within a received image.

The pose estimator engine 170 processes the image to determine a mapped pose model which includes a series of key points related to the major joints of a person. FIG. 1B depicts an example pose model 190 including seventeen key points related to the head, shoulders, arms, hands, hips, and legs of a person identified in the image. Key points 195a-195c are depicted in FIG. 1A. A key point is shown as a dot in the pose model 190. At least some of the key points can be connected by lines such that the key points and lines are representative of the general body configuration of a person.

The pose model 190 includes two key points at the end of a sequence of key points associated with the arms of a detected person, each of which are labeled ‘Hand’ in FIG. 1B. These key points are associated with respective hands of the detected person and are referred to as ‘hand key points’ in this specification. The threat analysis engine 110 processes information related to the hand key points to determine the presence of a weapon such as a firearm, or non-weapon object, in the hands of the detected person. The hand key points can be differentiated by the threat identification system 100 as ‘firsthand,’ ‘second hand,’ ‘right hand,’ or ‘left hand.’

The pose estimator engine 170 maps the key points for the pose model 190 to corresponding portions of the detected person depicted in the image. The pose estimator engine 170 estimates a location of at least some key points, e.g., each key point, representing a corresponding joint. The mapped pose model provides an estimated location for at least some, e.g., all, of the key points included in the pose model 190 within the image. In some examples, the mapped pose model includes information representative of an estimated location of at least some, e.g., each, key point in the image, and a confidence score associated with the key point. The confidence score can be a value representative of an accuracy of the location of the corresponding associated key point. In some examples, the pose estimator engine 170 estimates a location of at least some key points with respect to the remaining key points. In such examples, the mapped pose model includes information representative of an estimated location of at least some of the key points with respect to at least some of the remaining key points.

The pose estimator engine 170 provides the mapped pose model to an object localization engine 180. The object localization engine 180 generates a hand-held object heat map model using the mapped pose model. The hand-held object heat map provides probabilistic spatial location information for the downstream hand-held object detection engine 120, pose identification engine 130, or any combination of these. The hand-held object detection engine 120 and pose identification engine 130 can use the probabilistic spatial location information to detect objects, classify detected objects into various object categories, determine a pose type using the probabilistic location of the hand key points, or a combination of two or more of these. The hand-held object heatmap includes a sequence of values indicating a likelihood that an object other than the detected person is depicted in a region of the image.

The hand-held object heatmap is determined from the image to include at least a portion of data representing the detected person using the data from the mapped pose model. In this manner, the hand-held object detection engine 120 can more accurately detect an object that is being held by the person by focusing on portions of the image which include the detected person, e.g., compared to other systems. Thus, the object localization engine 180 determines the hand-held object heat map using the location of the hand key points in the received image.

The threat identification system 100 provides the mapped pose model and the hand-held object heat map to a threat analysis engine 110. The threat analysis engine 110 can use the received information to determine whether the person is holding a hand-held firearm, an estimated pose of the person depicted in the image, or any combination of these. The threat identification system 100 can determine whether to provide an alert, e.g., using a result of one or both of the determinations regarding whether the person is holding a hand-held firearm, or the estimated pose of the person. In response to determining to provide an alert, the threat identification system 100 provides instructions associated with the alert to connected systems. In some instances, the threat identification system can generate the alert, the instructions, or both, using data indicating the presence of a hand-held firearm, the estimated pose, or both.

The threat analysis engine 110 includes a hand-held object detection engine 120, a pose identification engine 130, and an alert generation engine 140. The hand-held object detection engine 120 and the pose identification engine 130 receive information from the pose estimator engine 170, the object localization engine 180, or both and perform the respective functions. These functions can be performed fully, or partially, in parallel, or sequentially. The hand-held object detection engine 120 and pose identification engine 130 functioning in parallel reduces the total processing time to determine the presence of a firearm and the probability of a threatening pose. Reducing the total processing time increases the speed by which an action can be determined responsive to the detected firearm and threatening pose, and information related to the action transmitted.

The hand-held object detection engine 120 determines the presence of a hand-held object. The hand-held object detection engine 120 classifies the hand-held object into one or more categories: a non-object, a non-weapon object, a weapon object, or any combination of these. The hand-held object detection engine 120 processes the mapped pose model and the hand-held object heat map to predict a likelihood that the person is holding a firearm. The hand-held object detection engine 120 can store a likelihood threshold value that, when satisfied, indicates whether the person is likely holding a firearm. The hand-held object detection engine 120 compares the likelihood to the likelihood threshold value to determine if the person is likely holding a firearm.

The non-weapon object may be an object which can be used in combination with a weapon object. In some examples, the non-weapon object is an object which a person may use to stabilize, aim, direct, or support the weapon object, or a combination of these. The non-weapon object, in some examples, may be a rest (e.g., a tri-pod, a bi-pod, or a mono-pod), or a sight (e.g., a scope, a laser sight, a thermal sight, a night vision sight, or a holographic sight). The non-weapon object may be identified by the object detection engine 120 alone, or in combination with weapon object.

An example of the hand-held object detection engine 120 is a pre-trained detection model trained on training images depicting objects. The hand-held object detection engine 120 can be trained on images of persons holding objects which are firearms, or other types of weapons, and objects which are not firearms or weapons to be able to distinguish between the two categories. The hand-held object detection engine 120 can be trained to receive input values indicating the size of the object in the image and use the size-related input values in the classification of the hand-held object.

The hand-held object detection engine 120 can use the hand-held object heatmap to identify a region of interest in the image. The hand-held object detection engine 120 identifies the region of interest using the hand key points from the mapped pose model and the values from the hand-held object heatmap. The hand-held object detection engine 120 determines whether one or more hand key points overlaps with a value from the hand-held object heatmap, e.g., a heatmap value that satisfies a corresponding threshold or any value from the heatmap. If the one or more hand key points overlaps with the hand-held object heatmap, the hand-held object detection engine 120 determines identifies the overlap region as a region of interest. This can facilitate processing the region of interest in the image in the identification and classification of the firearm within the image.

If the hand-held object detection engine 120 determines that a firearm is likely detected at one, or both, hand key points, the hand-held object detection engine 120 optionally determines a firearm type, a weapon type, another type of sub-weapon type, or any combination of these. Firearms can be broadly categorized into different types which depend on the size, configuration, type of ammunition, or rate of fire. Non-limiting examples of firearm types include one-handed firearms and two-handed firearms. Non-limiting examples of one-handed firearms include pistols (e.g., semi-automatic pistols, or revolver pistols). Non-limiting examples of two-handed firearms include rifles (e.g., automatic rifles, semi-automatic rifles, single-shot rifles), or shotguns (e.g., semi-automatic shotguns, or single-shot shotguns).

Some firearms can be handled either as a one-handed firearm, or as a two-handed firearm. In some examples, a firearm is a submachine gun sized and configured for one-handed, or two-handed, operation. When the hand-held object detection engine 120 determines that the firearm is likely detected at one, or both, hand key points of the mapped pose model, the hand-held object detection engine 120 can optionally update the classification of the object from one-handed to two-handed (or vice-versa) in subsequent image processing steps.

The pose identification engine 130 determines a pose type using the received image. Non-limiting examples of the pose type include ‘threatening,’ or ‘neutral.’ A threatening pose is indicative of an elevated level of aggression of the detected person, e.g., when one or more aggression criteria is satisfied, and a neutral pose is indicative of a comparatively low level of aggression of the detected person, e.g., when the one or more aggression criteria are not satisfied. For example, the pose identification engine 130 can output a threatening pose type if the hand key points are at or above shoulder-related key points and proximate to a facial-related key point of the mapped pose model. In some examples, the pose identification engine 130 can output a low threatening pose probability value if the hand key points are proximate to hip-related key points. As described above, the pose identification engine 130 can at least partially in parallel with the hand-held object detection engine 120. Optionally, the identification engine 130 determines the pose type using a hand-held object heat map.

Optionally, the pose identification engine 130 determines the pose type using the presence of a hand-held object, the classification of a hand-held object, or a combination of these. In some examples, the hand-held object detection engine 120 determines that a firearm is likely detected at one, or both, hand key points and determines that a non-weapon object which a person may use to stabilize, aim, direct, or support the weapon object is likely detected. The pose identification engine 130 can use the likelihood that both the weapon object and the non-weapon object is detected to determine the pose type as threatening or non-threatening. The likelihood can be a likelihood specific to one of the two determinations, e.g., there can be two likelihoods, or for both determinations.

Optionally, the pose identification engine 130 determines a threatening pose probability value of the detected person using the mapped pose model. The threatening pose probability value is a value representative of a likelihood of a level of aggression that the mapped pose model indicates given the relative positioning of the key points to each other. The pose identification engine 130 can compare the threatening pose probability value to a threatening pose threshold value. The pose identification engine 130 determines that the pose type is a threatening pose type if the threatening pose probability value meets or exceeds a threatening pose threshold value.

Optionally, the pose identification engine 130 can output a likelihood of a threatening pose using the mapped pose model. The likelihood is a value representative of the probability that the detected person is in a threatening pose in response to the received mapped pose model. Examples of the likelihood of the threatening pose value include a normalized value, e.g., from 0 to 1, a scaled value, e.g., from 0 to 100, or any other appropriate type of value.

The threat analysis engine 110 receives the likelihood that the person is holding a firearm from the hand-held object detection engine 120 and the pose type from the pose identification engine 130 and provides both to the alert generation engine 140. The alert generation engine 140 processes the likelihood and the post type to determine an action to perform for the detected person using the likelihood and the pose type. In some examples, the alert generation engine 140 selects the action from a pre-determined list of actions accessible by the alert generation engine 140.

Non-limiting examples of actions which can be stored in the pre-determined list of actions include modulating a door state (e.g., closing, opening, locking, or unlocking a door), triggering an alarm (e.g., an audio alarm, a visual alarm, or both), modulating a lighting state (e.g., turning at least some lights on, turning at least some lights off), or activating one or more notifications (e.g., transmitting a notification of the detected aggressive person to a third party).

The threat identification system 100 transmits instructions to cause a device to perform the action. The device to which the threat identification system 100 transmits the instructions depends on the action determined by the threat identification system 100. The threat identification system 100 can store one or more device associated with an action and transmit instructions according to the associated device. In some examples, the threat identification system 100 selects the device to which to transmit instructions using the actions the device can perform.

In some examples, the threat identification system 100 is operating within a shooting range having multiple doors and visual signals indicating whether the shooting range is ‘hot’ or ‘cold.’ The threat identification system 100 detects a person that is holding a firearm and displaying a threatening pose type. The threat identification system 100 transits instructions to at least some of the multiple doors to unlock and transmits instructions to the visual signals to indicate that the shooting range is in an unexpected ‘hot’ state.

The threat identification system 100 is an example of a system implemented as computer programs on one or more computers in one or more locations, in which the systems, components, and techniques described in this specification are implemented. The devices can include personal computers, mobile communication devices, doors, speakers, alarms, lights, and other devices that can send and receive data over a network. The network (not shown), such as a local area network (“LAN”), wide area network (“WAN”), the Internet, or a combination thereof, connects the devices, and the threat identification system 100. The threat identification system 100 can use a single computer or multiple computers operating in conjunction with one another, including, for example, a remote computer deployed as a cloud computing service.

The threat identification system 100 can include several different functional components, including a hand-held object detection engine 120, pose identification engine 130, an alert generation engine 140, an object detector engine 150, an image cropping engine 160, an estimator engine 170, and an object localization engine 180. The hand-held object detection engine 120, pose identification engine 130, alert generation engine 140, object detector engine 150, image cropping engine 160, estimator engine 170, and object localization engine 180, or a combination of these, can include one or more data processing apparatuses, can be implemented in code, or a combination of both. For instance, the hand-held object detection engine 120, pose identification engine 130, alert generation engine 140, object detector engine 150, image cropping engine 160, estimator engine 170, and object localization engine 180, or a combination of these, can include one or more data processors and instructions that cause the one or more data processors to perform the operations discussed herein.

The various functional components of the threat identification system 100 can be installed on one or more computers as separate functional components or as different modules of a same functional component. For example, the components of the threat identification system 100 can be implemented as computer programs installed on one or more computers in one or more locations that are coupled through a network. In cloud-based systems for example, these components can be implemented by individual computing nodes of a distributed computing system.

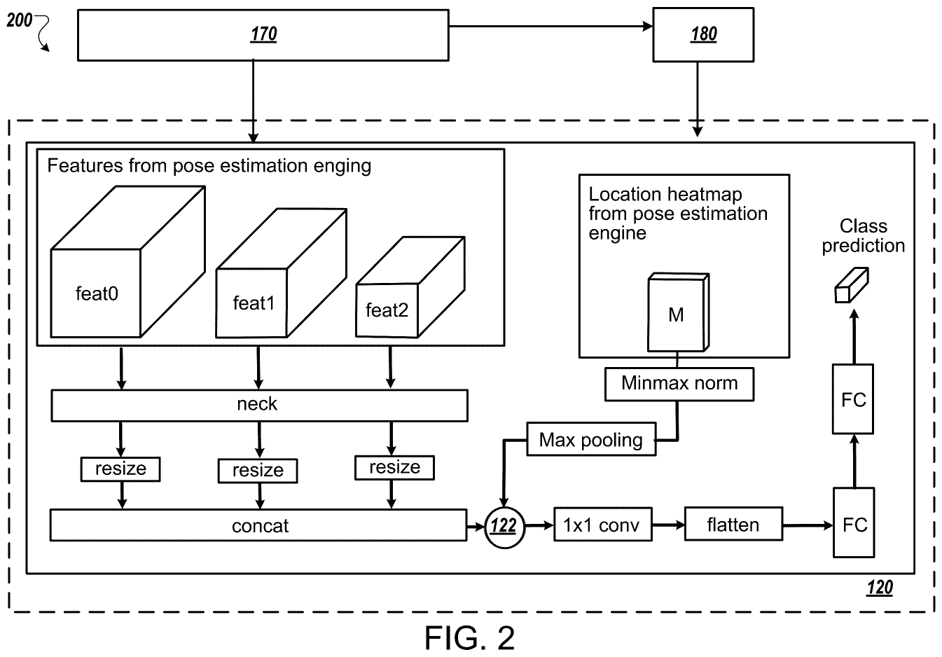

FIG. 2 is a block diagram showing an example environment 200 that includes the hand-held object detection engine 120 of FIG. 1A. The hand-held object detection engine 120 enhances the mapped pose model from the pose estimator engine 170 for classification. The hand-held object detection engine 120 modulates the mapped pose model using the hand-held object heat map to produce heat map-modulated features so that downstream processing will more likely attend to the features with high weights in the heat maps. The hand-held object detection engine 120 further processes the heat map-modulated features and final classification of a detected hand-held object. The hand-held object detection engine 120 shown in FIG. 2 is one implementation example of a hand-held object detection engine. In some examples, the hand-held object detection engine 120 can differ in terms of how the backbone features are enhanced, if and how the heat maps are normalized, how the modulated features are vectorized before final classification, e.g., using direct vectorization through flattening operations or through global pool operations for spatial feature aggregation, or any combination of these.

The estimator engine 170 groups different features into different feature groups having different feature scales. Feature scales can refer to features that the estimator engine 170 determines that capture information at different spatial scales, e.g., different spatial scales within an image. Spatial scale can refer to a size in a standard unit of measurement (e.g., inches, feet, centimeters, or meters) or pixels of the feature within the image. In some examples, features representing a person have a spatial scale of about 4 feet to 7 feet while features representing a weapon have a spatial scale of about 0.25 feet to 3 feet.

The estimator engine 170 provides the image features as different feature groups to the hand-held object detection engine 120. Three groups of image features are shown in FIG. 2 as feature group ‘feat0,’ feature group ‘feat1,’ and feature group ‘feat2.’ In some examples, the estimator engine 170 provides the image features as more than one, e.g., three, e.g., five, feature groups.

The hand-held object detection engine 120 receives the feature groups from the estimator engine 170. Each of the feature groups can be mixed up within the neck to enhance the feature description capability and provide enhanced feature groups. Each feature group which undergoes mixing may result in a corresponding enhanced feature group. Mixing can be a function in which the different spatial scales of the different feature groups are mixed. The mixing can enrich each feature group with context from the other feature groups, e.g., making the estimator engine 170 than it otherwise would be.

The hand-held object detection engine 120 resizes each of the enhanced feature groups, e.g., after mixing in the neck to the same spatial size. The hand-held object detection engine 120 can concatenate each of the feature groups into a single enhanced feature set.

Optionally, the hand-held object detection engine 120 receives the hand-held object localization heatmap from the object localization engine 180. The object localization heatmap can be normalized to keep a magnitude of the object localization heatmap within a fixed range. The normalized object localization heatmap can be down sampled, e.g., by max pooling. In some examples, max pooling is a pooling operation that calculates the maximum value for patches of a feature map and uses the maximum value to create a down sampled (pooled) object localization heatmap. The down sampled object localization heatmap map has a reduced dimensionality than the source normalized object localization heatmap.

The hand-held object detection engine 120 can combine the enhanced feature set and the down sampled object localization heatmap to produce a product matrix 122. The combination operation can be any appropriate type of combination, such as multiplication, addition, subtraction, division, or any combination of these. In some examples, the multiplication is elementwise multiplication. The product matrix 122 is provided to a kernel size convolution layer (e.g., a 1×1 kernel size convolution layer) to reduce the dimensionality for the product matrix 122. The hand-held object detection engine 120 flattens the reduced product matrix using a flattening algorithm.

The hand-held object detection engine 120 can provide the flattened product matrix to a multi-layer perceptron (e.g., a 2-layer perceptron). The multi-layer perceptron determines a final confidence score for one or more categories using the flattened product matrix. In some examples, the categories include weapon categories and generic object categories. The weapons categories can include a single category, e.g., for “weapon”, or multiple categories, e.g., for different weapon types. In some examples, the multi-layer perceptron determines more than one final confidence score each of which corresponding to a respective category. This can occur when the hand-held object detection engine 120 uses multiple categories. The hand-held object detection engine 120 compares the more than one final confidence score to determine which category includes the highest final confidence score. The hand-held object detection engine 120 can provide the category having the highest final confidence score to the alert generation engine 140. The hand-held object detection engine 120 may compare the confidence score to one or more category confidence criterion to determine a corresponding category the confidence score satisfies.

The threat identification system 100 includes a firearm-related pose classifier to allow identification of firearm-related threats according to body pose. This includes when a hand-held firearm is visible in a received image, when the hand-held firearm is occluded, or the detected person is distant from camera thus reducing firearm identification accuracy and location.

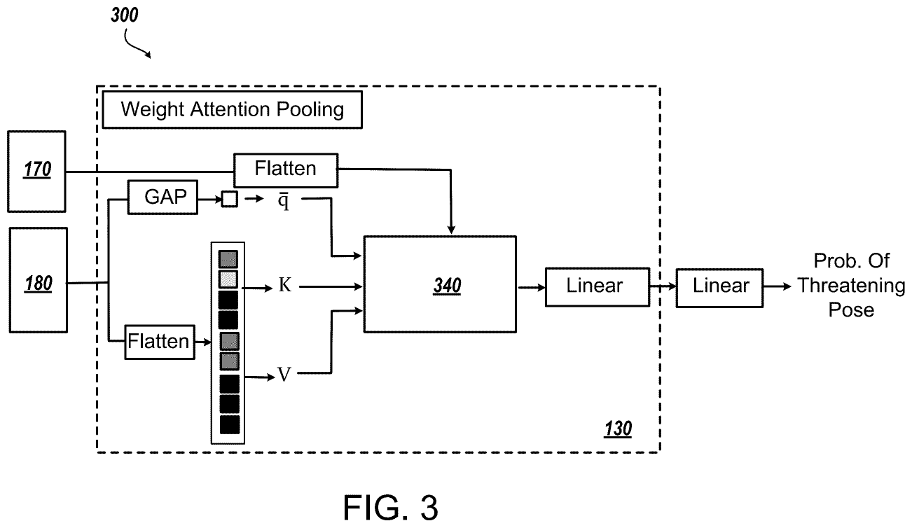

FIG. 3 is a block diagram showing an example environment 300 that includes the pose identification engine 130 of FIG. 1A. The pose identification engine 130 uses an attention pooling, e.g., a weighted attention pooling process, to process the mapped pose model. The pose identification engine 130 improves the spatial feature pooling process for final pose classification such that features with higher attention have a bigger impact on final feature pooling than features with lower attention.

The pose identification engine 130 receives the mapped pose model and processes the mapped pose model using global average pooling (GAP). GAP is a pooling operation which generates a single feature map from the mapped pose model. The pose identification engine 130 generates and average value for at least some of the features in the mapped pose model, e.g., all of the features, to generate a mapped pose model vector which is provided to the weighted scaled dot-product attention engine 340.

The pose identification engine 130 flattens the mapped pose model into a matrix with the individual features at corresponding grid positions, e.g., at every feature grid position. The resulting matrix is provided as well to the scaled dot-product attention engine 340.

The weighted scaled dot-product attention engine 340 can determine an attention vector using a softmax function. One example of a softmax function is shown in Equation (1), below.

$$attention ( \overline{q} , K , V ) = softmax ( \frac{\overline{q} {K}^{T}}{\sqrt{d}} ) \qquad ( 1 )$$

In Equation (1), q̅ is the average pooling of the features, K and V represents the individual features at different feature grid locations, and d is dimensionality of the features. T indicates the transpose of matrix, e.g., vector, K.

The weighted scaled dot-product attention engine 340 provides the attention vector to the pose identification engine 130. The pose identification engine 130 linearizes the attention vector into the threatening pose probability value. The pose identification engine 130 outputs the threatening pose probability value to the threat analysis engine 110.

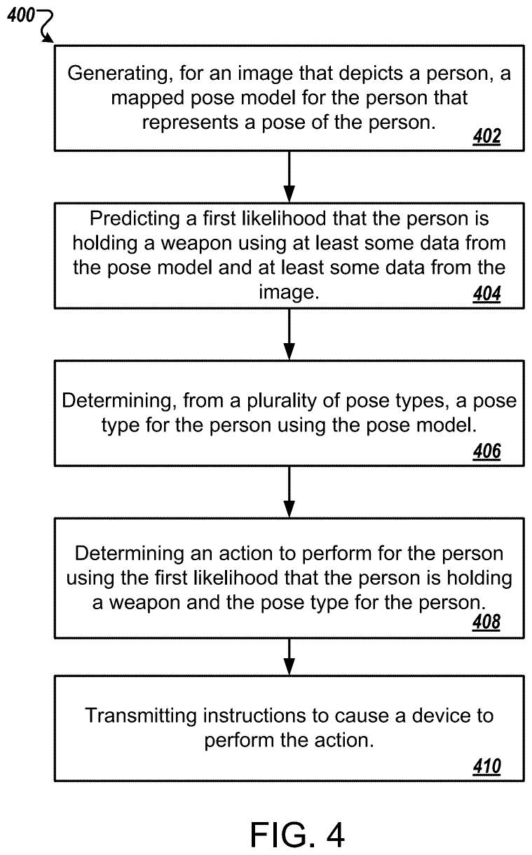

FIG. 4 is a flow diagram of a process 400 for monitoring an environment for a person holding a weapon using a pose. For example, the process 400 can be used by the threat identification system 100.

A system generates, for an image that depicts a person, a mapped pose model for the person that represents a pose of the person (402). In some examples, the mapped pose model is the mapped pose model generated by the pose estimator engine 170. The mapped pose model includes multiple key points corresponding to joints of a human model, a key point representing a joint of the detected person and an associated location, e.g., a location in the image, or a location with respect to another key point, used to generate the mapped pose model.

The system predicts a first likelihood that the person is holding a weapon using at least some data from the pose model and at least some data from the image (404). The threat identification system 100 provides output from the pose estimator engine 170 and the object localization engine 180 to a hand-held object detection engine 120. The hand-held object detection engine 120 is an object classifier that uses the hand-held object heat map from the object localization engine 180 to perform object identification and classification localized to the hand key points of the mapped pose model. The hand-held object detection engine 120 outputs a detected weapon location and, optionally, a determined weapon type.

The system determines, from a plurality of pose types, a pose type for the person using the pose model (406). The threat identification system 100 provides the mapped pose model to a pose identification engine 130. The pose identification engine 130 classifies a pose type from the mapped pose model. Optionally, the pose identification engine 130 determines a threatening pose probability value that can represent the pose type. Optionally, the threat identification system 100 provides the hand-held object heat map to the pose identification engine 130. The pose identification engine 130 optionally classifies the post type from the mapped pose model and the hand-held object heat map.

The system determines an action to perform for the person using the first likelihood that the person is holding a weapon and the pose type for the person (408). The threat identification system 100 uses the alert generation engine 140 to determine an action in response to the detected weapon location, the pose type, or any combination of these. Optionally, the threat identification system 100 uses the alert generation engine 140 to determine an action in response to a determined weapon type, a threatening pose probability value, or any combination of these. The alert generation engine 140 stores a list of actions and associated threshold parameters. The list of actions can include a mapping for at least some combinations, e.g., all combinations, of the detected weapon location, optional determined weapon type, the pose type, and optional threatening pose probability value. The alert generation engine 140 selects one or more actions from the stored list of actions using the determined parameters.

The system transmits instructions to cause a device to perform the action (410). The threat identification system 100 can store a list of devices and the functions which a device is operable to perform. The threat identification system 100 transmits instructions to one or more of the devices to perform their listed functions in response to the action determined by the alert generation engine 140.

In some examples, the threat identification system 100 can transmit instructions to one or more robots, e.g., drones, to perform an instructed function. The threat identification system 100 may transmit instructions to the one or more robots to traverse an area in which in which the threat identification system 100 determines the person to be in. The threat identification system 100 may transmit instructions to the one or more robots to acquire one or more images of the area in which the person may be in. The threat identification system 100 may transmit instructions to the one or more robots to perform actions which may attract the attention of the person.

In some examples, the threat identification system 100 transmitting instructions can alter access of the person to an area, e.g., by transmitting instructions to an access control unit. The threat identification system 100 transmitting instructions can cause, or deny, access to the area by the person. The threat identification system 100 can cause, or deny, access to the area that the person is in, that the person has been, that the person is predicted to go to, or a combination of these. Altering the access of the area may change, e.g., reduce, the ability of the person to move between areas. The access control unit may be an automated lock, e.g., a magnetic lock, of a door, a window, a vent, a skylight, an access panel, or a combination of these.

In some examples, the threat identification system 100 can transmit instructions to a security device of a building in which the threat identification system 100 determines the person to be in. The threat identification system 100 can transmit instructions to, as example security devices, one or more alarms, e.g., a visual, auditory, or silent alarm, a keycard readers, a biometric scanner (e.g., fingerprint, retina, facial recognition), a keypad, a turnstile, a gate, an intercom system, or any combination of these.

In some examples, the threat identification system 100 can transmit instructions to an emergency response system, e.g., a police response system, an emergency medical team response system, or both. The threat identification system 100 transmitting instructions to the emergency response system may reduce the response time of first responders to the area in which the threat identification system 100 determines the person to be in. Reducing the response time of the first responders can increase the safety of the area in which the threat identification system 100 determines the person to be.

In some examples, the threat identification system 100 may use at least some data of the pose model, data from an image, data from the object classifier, or combination of these, in transmitting instructions. The threat identification system 100 may transmit the first likelihood that the person is holding a weapon, a classification of the object that the person may be holding, a pose type of the person, or a combination of these. In some instances, the thread identification system 100 can generate the instructions using data that indicates the first likelihood that the person is holding a weapon, a classification of the object that the person may be holding, a pose type of the person, or a combination of these.

The order of operations in the process 400 described above is illustrative only and can be performed in different orders. For example, the system can predict a first likelihood that the person is holding a weapon (404) and determine a pose type for the person (406) fully, or partially, in parallel.

In some implementations, the process 400 can include additional operations, fewer operations, or some of the operations can be divided into multiple operations. For example, the system can generate a heat map that indicates a likelihood that an object other than the person is depicted in a region of the image that includes at least a portion of the person using the data from the pose model.

In some implementations, the system is implemented at least in part on an edge device, e.g., a camera that captures the image depicting the person. In these implementations, the camera can perform one or more of the operations of the process 400. In some examples, another system, e.g., a cloud system, can perform some of the operations of the process 400. For instance, the camera can transmit the first likelihood that the person is holding a weapon and the pose type for the person to the cloud system. The cloud system can use the first likelihood that the person is holding a weapon and the pose type for the person to determine the action, e.g., perform operation 408).

In some implementations, certain data may be anonymized in one or more ways before it is stored or used, so that personally identifiable information is removed. For example, a person's identity may be anonymized so that no personally identifiable information can be determined for the person.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine,” e.g., a detector or other type of module, is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

In this specification, the term likely is used to mean that there is a likelihood that something might occur and that likelihood satisfies a likelihood threshold. For instance, when determining that a weapon is likely depicted in an image, a system would determine a likelihood that the weapon is depicted in the image. The system would then determine whether the likelihood satisfies, e.g., is greater than or equal to, a likelihood threshold by comparing the two values. If so, the system determines that the weapon is likely depicted in the image. If not, the system determines that the weapon is not likely depicted in the image. In some examples, a threshold may be referred to as a criterion, e.g., a likelihood threshold may be a likelihood criterion.

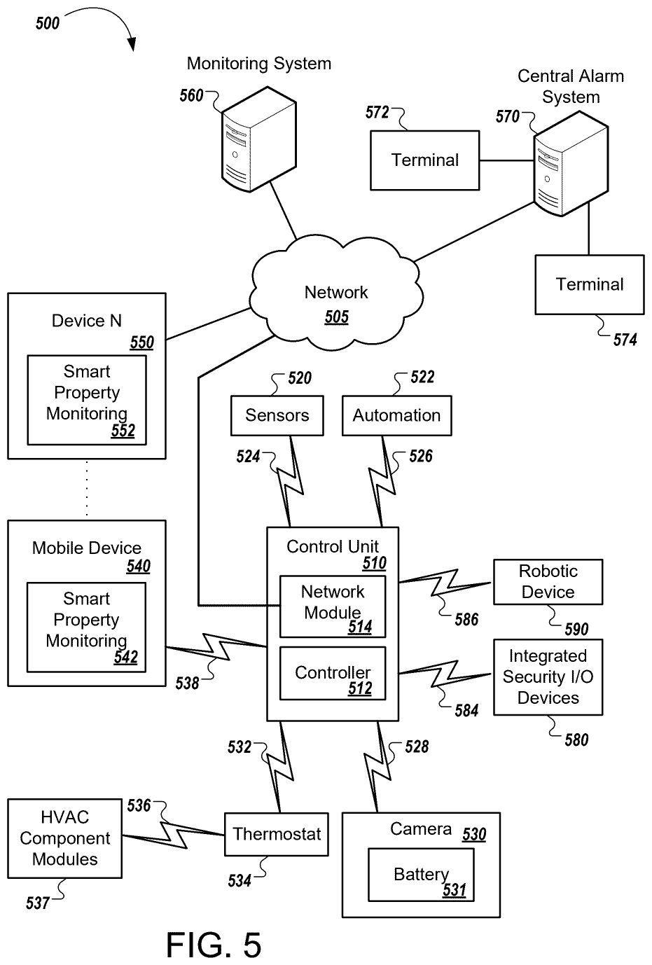

FIG. 5 is a diagram illustrating an example of an environment 500, e.g., for monitoring a property. The property can be any appropriate type of property, such as a home, a business, or a combination of both. The environment 500 includes a network 505, a control unit 510, one or more devices 540 and 550, a monitoring system 560, a central alarm system 570, or a combination of two or more of these. In some examples, the network 505 facilitates communications between two or more of the control unit 510, the one or more devices 540 and 550, the monitoring system 560, and the central alarm system 570.

The network 505 is configured to enable exchange of electronic communications between devices connected to the network 505. For example, the network 505 can be configured to enable exchange of electronic communications between the control unit 510, the one or more devices 540 and 550, the monitoring system 560, and the central alarm system 570. The network 505 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 505 can include multiple networks or subnetworks, each of which can include, for example, a wired or wireless data pathway. The network 505 can include a circuit-switched network, a packet-switched data network, or any other network able to carry electronic communications (e.g., data or voice communications). For example, the network 505 can include networks using the Internet protocol (“IP”), asynchronous transfer mode (“ATM”), the PSTN, packet-switched networks using IP, X.25, or Frame Relay, or other comparable technologies and can support voice using, for example, voice over IP (“VOIP”), or other comparable protocols used for voice communications. The network 505 can include one or more networks that include wireless data channels and wireless voice channels. The network 505 can be a broadband network.

The control unit 510 includes a controller 512 and a network module 514. The controller 512 is configured to control a control unit monitoring system, e.g., a control unit system, that includes the control unit 510. In some examples, the controller 512 can include one or more processors or other control circuitry configured to execute instructions of a program that controls operation of a control unit system. In these examples, the controller 512 can be configured to receive input from sensors, or other devices included in the control unit system and control operations of devices at the property, e.g., speakers, displays, lights, doors, other appropriate devices, or a combination of these. For example, the controller 512 can be configured to control operation of the network module 514 included in the control unit 510.

The network module 514 is a communication device configured to exchange communications over the network 505. The network module 514 can be a wireless communication module configured to exchange wireless, wired, or a combination of both, communications over the network 505. For example, the network module 514 can be a wireless communication device configured to exchange communications over a wireless data channel and a wireless voice channel. In some examples, the network module 514 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 514 can be a wired communication module configured to exchange communications over the network 505 using a wired connection. For instance, the network module 514 can be a modem, a network interface card, or another type of network interface device. The network module 514 can be an Ethernet network card configured to enable the control unit 510 to communicate over a local area network, the Internet, or a combination of both. The network module 514 can be a voice band modem configured to enable the alarm panel to communicate over the telephone lines of Plain Old Telephone Systems (“POTS”).

The control unit system that includes the control unit 510 can include one or more sensors 520. For example, the environment 500 can include multiple sensors 520. The sensors 520 can include a lock sensor, a contact sensor, a motion sensor, a camera (e.g., a camera 530), a flow meter, any other type of sensor included in a control unit system, or a combination of two or more of these. The sensors 520 can include an environmental sensor, such as a temperature sensor, a water sensor, a rain sensor, a wind sensor, a light sensor, a smoke detector, a carbon monoxide detector, or an air quality sensor, to name a few additional examples. 520 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 520 can include a radio-frequency identification (“RFID”) sensor that identifies a particular article that includes a pre-assigned RFID tag.

The control unit 510 can communicate with a module 522 and a camera 530 to perform monitoring. The module 522 is connected to one or more devices that enable property automation, e.g., home or business automation. For instance, the module 522 can connect to, and be configured to control operation of, one or more lighting systems. The module 522 can connect to, and be configured to control operation of, one or more electronic locks, e.g., control Z-Wave locks using wireless communications in the Z-Wave protocol. In some examples, the module 522 can connect to, and be configured to control operation of, one or more appliances. The module 522 can include multiple sub-modules that are each specific to a type of device being controlled in an automated manner. The module 522 can control the one or more devices using commands received from the control unit 510. For instance, the module 522 can receive a command from the control unit 510, which command was sent using data captured by the camera 530 that depicts an area. In response, the module 522 can cause a lighting system to illuminate an area to provide better lighting in the area, and a higher likelihood that the camera 530 can capture a subsequent image of the area that depicts more accurate data of the area.

The camera 530 can be an image camera or other type of optical sensing device configured to capture one or more images. For instance, the camera 530 can be configured to capture images of an area within a property monitored by the control unit 510. The camera 530 can be configured to capture single, static images of the area; video of the area, e.g., a sequence of images; or a combination of both. The sequence of images can be a sequence of frames, e.g., when the video is compressed using a video codec. The image captured by the camera can be any appropriate type of image, e.g., a frame. The camera 530 can be controlled using commands received from the control unit 510 or another device in the property monitoring system, e.g., a device 550.

The camera 530 can be triggered using any appropriate techniques, can capture images continuously, or a combination of both. For instance, a Passive Infra-Red (“PIR”) motion sensor can be built into the camera 530 and used to trigger the camera 530 to capture one or more images when motion is detected. The camera 530 can include a microwave motion sensor built into the camera which is used to trigger the camera 530 to capture one or more images when motion is detected. The camera 530 can have a “normally open” or “normally closed” digital input that can trigger capture of one or more images when external sensors detect motion or other events. The external sensors can include another sensor from the sensors 520, PIR, or door or window sensors, to name a few examples. In some implementations, the camera 530 receives a command to capture an image, e.g., when external devices detect motion or another potential alarm event or in response to a request from a device. The camera 530 can receive the command from the controller 512, directly from one of the sensors 520, or a combination of both.

In some examples, the camera 530 triggers integrated or external illuminators to improve image quality when the scene is dark. Some examples of illuminators can include Infra-Red, Z-wave controlled “white” lights, lights controlled by the module 522, or a combination of these. An integrated or separate light sensor can be used to determine if illumination is desired and can result in increased image quality.

The camera 530 can be programmed with any combination of time schedule, day schedule, system “arming state”, other variables, or a combination of these, to determine whether images should be captured when one or more triggers occur. The camera 530 can enter a low-power mode when not capturing images. In this case, the camera 530 can wake periodically to check for inbound messages from the controller 512 or another device. The camera 530 can be powered by internal, replaceable batteries, e.g., if located remotely from the control unit 510. The camera 530 can employ a small solar cell to recharge the battery when light is available. The camera 530 can be powered by a wired power supply, e.g., the controller's 512 power supply if the camera 530 is co-located with the controller 512.

In some implementations, the camera 530 communicates directly with the monitoring system 560 over the network 505. In these implementations, image data captured by the camera 530 need not pass through the control unit 510. The camera 530 can receive commands related to operation from the monitoring system 560, provide images to the monitoring system 560, or a combination of both.

The environment 500 can include one or more thermostats 534, e.g., to perform dynamic environmental control at the property. The thermostat 534 is configured to monitor temperature of the property, energy consumption of a heating, ventilation, and air conditioning (“HVAC”) system associated with the thermostat 534, or any combination of these. In some examples, the thermostat 534 is configured to provide control of environmental (e.g., temperature) settings. In some implementations, the thermostat 534 can additionally or alternatively receive data relating to activity at a property; environmental data at a property, e.g., at various locations indoors or outdoors or both at the property; or a combination of both. The thermostat 534 can measure or estimate energy consumption of the HVAC system associated with the thermostat. The thermostat 534 can estimate energy consumption, for example, using data that indicates usage of one or more components of the HVAC system associated with the thermostat 534. The thermostat 534 can communicate various data, e.g., temperature, energy, or both, with the control unit 510. In some examples, the thermostat 534 can control the environment, e.g., temperature, settings in response to commands received from the control unit 510.

In some implementations, the thermostat 534 is a dynamically programmable thermostat and can be integrated with the control unit 510. For example, the dynamically programmable thermostat 534 can include the control unit 510, e.g., as an internal component to the dynamically programmable thermostat 534. In some examples, the control unit 510 can be a gateway device that communicates with the dynamically programmable thermostat 534. In some implementations, the thermostat 534 is controlled via one or more modules 522.

The environment 500 can include the HVAC system or otherwise be connected to the HVAC system. For instance, the environment 500 can include one or more HVAC modules 537. The HVAC modules 537 can be connected to one or more components of the HVAC system associated with a property. A module 537 can be configured to capture sensor data from, control operation of, or both, corresponding components of the HVAC system. In some implementations, the module 537 is configured to monitor energy consumption of an HVAC system component, for example, by directly measuring the energy consumption of the HVAC system components or by estimating the energy usage of the one or more HVAC system components by detecting usage of components of the HVAC system. The module 537 can communicate energy monitoring information, the state of the HVAC system components, or both, to the thermostat 534. The module 537 can control the one or more components of the HVAC system in response to receipt of commands received from the thermostat 534.

In some examples, the environment 500 includes one or more robotic devices 590. The robotic devices 590 can be any type of robots that are capable of moving, such as an aerial drone, a land-based robot, or a combination of both. The robotic devices 590 can take actions, such as capture sensor data or other actions that assist in security monitoring, property automation, or a combination of both. For example, the robotic devices 590 can include robots capable of moving throughout a property using automated navigation control technology, user input control provided by a user, or a combination of both. The robotic devices 590 can fly, roll, walk, or otherwise move about the property. The robotic devices 590 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 590 can be robotic devices 590 that are intended for other purposes and merely associated with the environment 500 for use in appropriate circumstances. For instance, a robotic vacuum cleaner device can be associated with the environment 500 as one of the robotic devices 590 and can be controlled to take action responsive to monitoring system events.

In some examples, the robotic devices 590 automatically navigate within a property. In these examples, the robotic devices 590 include sensors and control processors that guide movement of the robotic devices 590 within the property. For instance, the robotic devices 590 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 590 can include control processors that process output from the various sensors and control the robotic devices 590 to move along a path that reaches the desired destination, avoids obstacles, or a combination of both. In this regard, the control processors detect walls or other obstacles in the property and guide movement of the robotic devices 590 in a manner that avoids the walls and other obstacles.

In some implementations, the robotic devices 590 can store data that describes attributes of the property. For instance, the robotic devices 590 can store a floorplan, a three-dimensional model of the property, or a combination of both, that enable the robotic devices 590 to navigate the property. During initial configuration, the robotic devices 590 can receive the data describing attributes of the property, determine a frame of reference to the data (e.g., a property or reference location in the property), and navigate the property using the frame of reference and the data describing attributes of the property. In some examples, initial configuration of the robotic devices 590 can include learning one or more navigation patterns in which a user provides input to control the robotic devices 590 to perform a specific navigation action (e.g., fly to an upstairs bedroom and spin around while capturing video and then return to a property charging base). In this regard, the robotic devices 590 can learn and store the navigation patterns such that the robotic devices 590 can automatically repeat the specific navigation actions upon a later request.

In some examples, the robotic devices 590 can include data capture devices. In these examples, the robotic devices 590 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 590 to take and store a biometric sample that can be used to identify the person (e.g., a biometric sample with DNA that can be used for DNA testing).

In some implementations, the robotic devices 590 can include output devices. In these implementations, the robotic devices 590 can include one or more displays, one or more speakers, any other type of output devices that allow the robotic devices 590 to communicate information, e.g., to a nearby user or another type of person, or a combination of these.

The robotic devices 590 can include a communication module that enables the robotic devices 590 to communicate with the control unit 510, each other, other devices, or a combination of these. The communication module can be a wireless communication module that allows the robotic devices 590 to communicate wirelessly. For instance, the communication module can be a Wi-Fi module that enables the robotic devices 590 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 590 to communicate with other devices, e.g., in or off the property. In some implementations, the robotic devices 590 can communicate with each other or with other devices of the environment 500 through the network 505.

The robotic devices 590 can include processor and storage capabilities. The robotic devices 590 can include any one or more suitable processing devices that enable the robotic devices 590 to execute instructions, operate applications, perform the actions described throughout this specification, or a combination of these. In some examples, the robotic devices 590 can include solid-state electronic storage that enables the robotic devices 590 to store applications, configuration data, collected sensor data, any other type of information available to the robotic devices 590, or a combination of two or more of these.

The robotic devices 590 can process captured data locally, provide captured data to one or more other devices for processing, e.g., the control unit 510 or the monitoring system 560, or a combination of both. For instance, the robotic device 590 can provide the images to the control unit 510 for processing. In some examples, the robotic device 590 can process the images to determine an identification of the items.

One or more of the robotic devices 590 can be associated with one or more charging stations. The charging stations can be located at a predefined home base or reference location in the property. The robotic devices 590 can be configured to navigate to one of the charging stations after completion of one or more tasks needed to be performed, e.g., for the environment 500. For instance, after completion of a monitoring operation or upon instruction by the control unit 510, a robotic device 590 can be configured to automatically fly to and connect with, e.g., land on, one of the charging stations. In this regard, a robotic device 590 can automatically recharge one or more batteries included in the robotic device 590 so that the robotic device 590 is less likely to need recharging when the environment 500 requires use of the robotic device 590, e.g., absent other concerns for the robotic device 590.

The charging stations can be contact-based charging stations, wireless charging stations, or a combination of both. For contact-based charging stations, the robotic devices 590 can have readily accessible points of contact to which a robotic device 590 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 590 can include a cover that opens to expose the electronic contact when the robotic device is charging and closes to cover and insulate the electronic contact when the robotic device 590 is in operation.

For wireless charging stations, the robotic devices 590 can charge through a wireless exchange of power. In these instances, a robotic device 590 needs only position itself closely enough to a wireless charging station for the wireless exchange of power to occur. In this regard, the positioning needed to land at a predefined home base or reference location in the property can be less precise than with a contact-based charging station. Based on the robotic devices 590 landing at a wireless charging station, the wireless charging station can output a wireless signal that the robotic device 590 receives and converts to a power signal that charges a battery maintained on the robotic device 590. As described in this specification, a robotic device 590 landing or coupling with a charging station can include a robotic device 590 positioning itself within a threshold distance of a wireless charging station such that the robotic device 590 is able to charge its battery.

In some implementations, one or more of the robotic devices 590 has an assigned charging station. In these implementations, the number of robotic devices 590 can equal the number of charging stations. In these implementations, the robotic devices 590 can always navigate to the specific charging station assigned to that robotic device 590. For instance, a first robotic device can always use a first charging station and a second robotic device can always use a second charging station.

In some examples, the robotic devices 590 can share charging stations. For instance, the robotic devices 590 can use one or more community charging stations that are capable of charging multiple robotic devices 590, e.g., substantially concurrently or separately or a combination of both at different times. The community charging station can be configured to charge multiple robotic devices 590 at substantially the same time, e.g., the community charging station can begin charging a first robotic device and then, while charging the first robotic device, begin charging a second robotic device five minutes later. The community charging station can be configured to charge multiple robotic devices 590 in serial such that the multiple robotic devices 590 take turns charging and, when fully charged, return to a predefined home base or reference location or another location in the property that is not associated with a charging station. The number of community charging stations can be less than the number of robotic devices 590.

In some instances, the charging stations might not be assigned to specific robotic devices 590 and can be capable of charging any of the robotic devices 590. In this regard, the robotic devices 590 can use any suitable, unoccupied charging station when not in use, e.g., when not performing an operation for the environment 500. For instance, when one of the robotic devices 590 has completed an operation or is in need of battery charge, the control unit 510 can reference a stored table of the occupancy status of each charging station and instructs the robotic device to navigate to the nearest charging station that has at least one unoccupied charger.

The environment 500 can include one or more integrated security devices 580. The one or more integrated security devices can include any type of device used to provide alerts using received sensor data. For instance, the one or more control units 510 can provide one or more alerts to the one or more integrated security input/output devices 580. In some examples, the one or more control units 510 can receive sensor data from the sensors 520 and determine whether to provide an alert, or a message to cause presentation of an alert, to the one or more integrated security input/output devices 580.

The sensors 520, the module 522, the camera 530, the thermostat 534, the module 537, the integrated security devices 580, and the robotic devices 590, can communicate with the controller 512 over communication links 524, 526, 528, 532, 536, 538, 584, and 586. The communication links 524, 526, 528, 532, 536, 538, 584, and 586 can be a wired or wireless data pathway configured to transmit signals between any combination of the sensors 520, the module 522, the camera 530, the thermostat 534, the module 537, the integrated security devices 580, the robotic devices 590, or the controller 512. The sensors 520, the module 522, the camera 530, the thermostat 534, the module 537, the integrated security devices 580, and the robotic devices 590, can continuously transmit sensed values to the controller 512, periodically transmit sensed values to the controller 512, or transmit sensed values to the controller 512 in response to a change in a sensed value, a request, or any combination of these. In some implementations, the robotic devices 590 can communicate with the monitoring system 560 over network 505. The robotic devices 590 can connect and communicate with the monitoring system 560 using a Wi-Fi or a cellular connection or any other appropriate type of connection.

The communication links 524, 526, 528, 532, 536, 538, 584, and 586 can include any appropriate type of network, such as a local network. The sensors 520, the module 522, the camera 530, the thermostat 534, the robotic devices 590 and the integrated security devices 580, and the controller 512 can exchange data and commands over the network.

The monitoring system 560 can include one or more electronic devices, e.g., one or more computers. The monitoring system 560 is configured to provide monitoring services by exchanging electronic communications with the control unit 510, the one or more devices 540 and 550, the central alarm system 570, or a combination of these, over the network 505. For example, the monitoring system 560 can be configured to monitor events (e.g., alarm events) generated by the control unit 510. In these examples, the monitoring system 560 can exchange electronic communications with the network module 514 included in the control unit 510 to receive information regarding events (e.g., alerts) detected by the control unit 510. The monitoring system 560 can receive information regarding events (e.g., alerts) from the one or more devices 540 and 550.

In some implementations, the monitoring system 560 might be configured to provide one or more services other than monitoring services. In these implementations, the monitoring system 560 might perform one or more operations described in this specification without providing any monitoring services, e.g., the monitoring system 560 might not be a monitoring system as described in the example shown in FIG. 5.

In some examples, the monitoring system 560 can route alert data received from the network module 514 or the one or more devices 540 and 550 to the central alarm system 570. For example, the monitoring system 560 can transmit the alert data to the central alarm system 570 over the network 505.

The monitoring system 560 can store sensor and image data received from the environment 500 and perform analysis of sensor and image data received from the environment 500. Based on the analysis, the monitoring system 560 can communicate with and control aspects of the control unit 510 or the one or more devices 540 and 550.

The monitoring system 560 can provide various monitoring services to the environment 500. For example, the monitoring system 560 can analyze the sensor, image, and other data to determine an activity pattern of a person of the property monitored by the environment 500. In some implementations, the monitoring system 560 can analyze the data for alarm conditions or can determine and perform actions at the property by issuing commands to one or more components of the environment 500, possibly through the control unit 510.

The central alarm system 570 is an electronic device, or multiple electronic devices, configured to provide alarm monitoring service by exchanging communications with the control unit 510, the one or more mobile devices 540 and 550, the monitoring system 560, or a combination of these, over the network 505. For example, the central alarm system 570 can be configured to monitor alerting events generated by the control unit 510. In these examples, the central alarm system 570 can exchange communications with the network module 514 included in the control unit 510 to receive information regarding alerting events detected by the control unit 510. The central alarm system 570 can receive information regarding alerting events from the one or more mobile devices 540 and 550, the monitoring system 560, or any combination of these. In some implementations, the central alarm system 570 can be implemented, at least in part if not entirely, on the monitoring system 560. In these implementations, the monitoring system 560 can perform the operations described with reference to the central alarm system 570. One or both of the monitoring system 560 or the central alarm system 570 can be implemented in the cloud.

The central alarm system 570 is connected to multiple terminals 572 and 574. The terminals 572 and 574 can be used by operators to process alerting events. For example, the central alarm system 570, e.g., as part of a first responder system, can route alerting data to the terminals 572 and 574 to enable an operator to process the alerting data. The terminals 572 and 574 can include general-purpose computers (e.g., desktop personal computers, workstations, or laptop computers) that are configured to receive alerting data from a computer in the central alarm system 570 and render a display of information using the alerting data.

For instance, the controller 512 can control the network module 514 to transmit, to the central alarm system 570, alerting data indicating that a sensor 520 detected motion from a motion sensor via the sensors 520. The central alarm system 570 can receive the alerting data and route the alerting data to the terminal 572 for processing by an operator associated with the terminal 572. The terminal 572 can render a display to the operator that includes information associated with the alerting event (e.g., the lock sensor data, the motion sensor data, the contact sensor data, etc.) and the operator can handle the alerting event using the displayed information. In some implementations, the terminals 572 and 574 can be mobile devices or devices designed for a specific function. Although FIG. 5 illustrates two terminals for brevity, actual implementations can include more (and, perhaps, many more) terminals.

The one or more devices 540 and 550 are devices that can present content, e.g., host and display user interfaces, audio data, or any combination of these. For instance, the mobile device 540 is a mobile device that hosts or runs one or more native applications (e.g., the smart property application 542). The mobile device 540 can be a cellular phone or a non-cellular locally networked device with a display. The mobile device 540 can include a cell phone, a smart phone, a tablet PC, a personal digital assistant (“PDA”), or any other portable device configured to communicate over a network and present information. The mobile device 540 can perform functions unrelated to the monitoring system, such as placing personal telephone calls, playing music, playing video, displaying pictures, browsing the Internet, and maintaining an electronic calendar.

The mobile device 540 can include a smart property application 542. The smart property application 542 refers to a software/firmware program running on the corresponding mobile device that enables the user interface and features described throughout. The mobile device 540 can load or install the smart property application 542 using data received over a network or data received from local media. The smart property application 542 enables the mobile device 540 to receive and process image and sensor data from the monitoring system 560.

The device 550 can be a general-purpose computer (e.g., a desktop personal computer, a workstation, or a laptop computer) that is configured to communicate with the monitoring system 560, the control unit 510, or both, over the network 505. The device 550 can be configured to display a smart property user interface 552 that is generated by the device 550 or generated by the monitoring system 560. For example, the device 550 can be configured to display a user interface (e.g., a web page) generated using data provided by the monitoring system 560 that enables a user to perceive images captured by the camera 530, reports related to the monitoring system, or any combination of these. Although FIG. 5 illustrates two devices for brevity, actual implementations can include more (and, perhaps, many more) or fewer devices.

In some implementations, the one or more devices 540 and 550 communicate with and receive data from the control unit 510 using the communication link 538. For instance, the one or more devices 540 and 550 can communicate with the control unit 510 using various wireless protocols, or wired protocols such as Ethernet and USB, to connect the one or more devices 540 and 550 to the control unit 510, e.g., local security and automation equipment. The one or more devices 540 and 550 can use a local network, a wide area network, or a combination of both, to communicate with other components in the environment 500. The one or more devices 540 and 550 can connect locally to the sensors and other devices in the environment 500.

Although the one or more devices 540 and 550 are shown as communicating with the control unit 510, the one or more devices 540 and 550 can communicate directly with the sensors and other devices controlled by the control unit 510. In some implementations, the one or more devices 540 and 550 replace the control unit 510 and perform one or more of the functions of the control unit 510 for local monitoring and long range, offsite, or both, communication.

In some implementations, the one or more devices 540 and 550 receive monitoring system data captured by the control unit 510 through the network 505. The one or more devices 540 and 550 can receive the data from the control unit 510 through the network 505, the monitoring system 560 can relay data received from the control unit 510 to the one or more devices 540 and 550 through the network 505, or a combination of both. In this regard, the monitoring system 560 can facilitate communication between the one or more devices 540 and 550 and various other components in the environment 500.

In some implementations, the one or more devices 540 and 550 can be configured to switch whether the one or more devices 540 and 550 communicate with the control unit 510 directly (e.g., through communication link 538) or through the monitoring system 560 (e.g., through network 505) using a location of the one or more devices 540 and 550. For instance, when the one or more devices 540 and 550 are located close to, e.g., within a threshold distance of, the control unit 510 and in range to communicate directly with the control unit 510, the one or more devices 540 and 550 use direct communication. When the one or more devices 540 and 550 are located far from, e.g., outside the threshold distance of, the control unit 510 and not in range to communicate directly with the control unit 510, the one or more devices 540 and 550 use communication through the monitoring system 560.

Although the one or more devices 540 and 550 are shown as being connected to the network 505, in some implementations, the one or more devices 540 and 550 are not connected to the network 505. In these implementations, the one or more devices 540 and 550 communicate directly with one or more of the monitoring system components and no network (e.g., Internet) connection or reliance on remote servers is needed.

In some implementations, the one or more devices 540 and 550 are used in conjunction with only local sensors and/or local devices in a house. In these implementations, the environment 500 includes the one or more devices 540 and 550, the sensors 520, the module 522, the camera 530, and the robotic devices 590. The one or more devices 540 and 550 receive data directly from the sensors 520, the module 522, the camera 530, the robotic devices 590, or a combination of these, and send data directly to the sensors 520, the module 522, the camera 530, the robotic devices 590, or a combination of these. The one or more devices 540 and 550 can provide the appropriate interface, processing, or both, to provide visual surveillance and reporting using data received from the various other components.

In some implementations, the environment 500 includes network 505 and the sensors 520, the module 522, the camera 530, the thermostat 534, and the robotic devices 590 are configured to communicate sensor and image data to the one or more devices 540 and 550 over network 505. In some implementations, the sensors 520, the module 522, the camera 530, the thermostat 534, and the robotic devices 590 are programmed, e.g., intelligent enough, to change the communication pathway from a direct local pathway when the one or more devices 540 and 550 are in close physical proximity to the sensors 520, the module 522, the camera 530, the thermostat 534, the robotic devices 590, or a combination of these, to a pathway over network 505 when the one or more devices 540 and 550 are farther from the sensors 520, the module 522, the camera 530, the thermostat 534, the robotic devices 590, or a combination of these.

In some examples, the monitoring system 560 leverages GPS information from the one or more devices 540 and 550 to determine whether the one or more devices 540 and 550 are close enough to the sensors 520, the module 522, the camera 530, the thermostat 534, the robotic devices 590, or a combination of these, to use the direct local pathway or whether the one or more devices 540 and 550 are far enough from the sensors 520, the module 522, the camera 530, the thermostat 534, the robotic devices 590, or a combination of these, that the pathway over network 505 is required. In some examples, the monitoring system 560 leverages status communications (e.g., pinging) between the one or more devices 540 and 550 and the sensors 520, the module 522, the camera 530, the thermostat 534, the robotic devices 590, or a combination of these, to determine whether communication using the direct local pathway is possible. If communication using the direct local pathway is possible, the one or more devices 540 and 550 communicate with the sensors 520, the module 522, the camera 530, the thermostat 534, the robotic devices 590, or a combination of these, using the direct local pathway. If communication using the direct local pathway is not possible, the one or more devices 540 and 550 communicate with the sensors 520, the module 522, the camera 530, the thermostat 534, the robotic devices 590, or a combination of these, using the pathway over network 505.

In some implementations, the environment 500 provides people with access to images captured by the camera 530 to aid in decision-making. The environment 500 can transmit the images captured by the camera 530 over a network, e.g., a wireless WAN, to the devices 540 and 550. Because transmission over a network can be relatively expensive, the environment 500 can use several techniques to reduce costs while providing access to significant levels of useful visual information (e.g., compressing data, down-sampling data, sending data only over inexpensive LAN connections, or other techniques).

In some implementations, a state of the environment 500, one or more components in the environment 500, and other events sensed by a component in the environment 500 can be used to enable/disable video/image recording devices (e.g., the camera 530). In these implementations, the camera 530 can be set to capture images on a periodic basis when the alarm system is armed in an “away” state, set not to capture images when the alarm system is armed in a “stay” state or disarmed, or a combination of both. In some examples, the camera 530 can be triggered to begin capturing images when the control unit 510 detects an event, such as an alarm event, a door-opening event for a door that leads to an area within a field of view of the camera 530, or motion in the area within the field of view of the camera 530. In some implementations, the camera 530 can capture images continuously, but the captured images can be stored or transmitted over a network when needed.

In some implementations, when a device or system transmits data to another device or system, the transmission of the data, such as a message, can cause the other device or system to perform one or more actions. For instance, transmission of a message that includes an instruction to the other device, e.g., a camera, can cause the other device, e.g., the camera, to perform an action. The action can be any appropriate type of action, such as capture one or more images, transmit one or more images to the device or system, open a door, launch an application, trigger an alert, present a user interface for an application, or any combination of these.

Although FIG. 5 depicts the monitoring system 560 as remote from the control unit 510, in some examples the control unit 510 can be a component of the monitoring system 560. For instance, both the monitoring system 560 and the control unit 510 can be physically located at a property that includes the sensors 520 or at a location outside the property.

In some examples, some of the sensors 520, the robotic devices 590, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 510, the monitoring system 560, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., a Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
generating, for an image that depicts a person, a mapped pose model for the person that represents a pose of the person;
predicting a first likelihood that the person is holding a weapon using at least some data from the mapped pose model and at least some data from the image;
determining, from a plurality of pose types, a pose type for the person using the mapped pose model;
determining an action to perform for the person using the first likelihood that the person is holding a weapon and the pose type for the person; and
transmitting instructions to cause a device to perform the action.

2. The method of claim 1, wherein:
the mapped pose model comprises three or more key points for the person; and
predicting the first likelihood that the person is holding a weapon uses one or more of a first point for a first hand of the person or a second point for a second hand of the person.

3. The method of claim 1, wherein predicting the first likelihood that the person is holding a weapon comprises:
generating a heat map that indicates a likelihood that an object other than the person is depicted in a region of the image that includes at least a portion of the person using the data from the mapped pose model; and
predicting the first likelihood using a classifier that classifies whether the person is holding a weapon using the heat map.

4. The method of claim 3, wherein predicting the first likelihood using the classifier that classifies whether the person is holding a weapon comprises:
computing, for at least one category of a plurality of categories and using the classifier, a corresponding confidence score that the weapon is of the corresponding category, the confidence score in one or more confidence scores each of which is for a corresponding category from the plurality of categories;
determining, using the one or more confidence scores, whether a confidence criterion is satisfied; and
determining the first likelihood using a confidence score from the one or more confidence scores that satisfies the confidence criterion.

5. The method of claim 1, wherein predicting the first likelihood uses a pre-trained weapon detection model trained i) on at least one training image that depicts an object and ii) using an input value, from a plurality of input values, that indicated a) a size of the object and b) an input value, from the plurality of input values, that the weapon detection model used to limit a region of the image for analysis of the object.

6. The method of claim 5, wherein the object is a hand-held object.

7. The method of claim 1, wherein detecting the pose type comprises:
determining a threatening pose probability value using the mapped pose model; and
determining the pose type using the threatening pose probability value.

8. The method of claim 7, wherein:
determining the action uses the threatening pose probability value and the pose type; and
transmitting the instructions comprises transmitting the instructions to cause the device to perform the action determined using the threatening pose probability value and the pose type.

9. The method of claim 8, wherein determining the pose type comprises:
determining whether the threatening pose probability value satisfies a threatening pose threshold value, and
in response to determining that the threatening pose probability value satisfies the threatening pose threshold value, selecting a threatening pose type.

10. The method of claim 7, wherein determining the threatening pose probability value comprises determining a threatening pose probability value using the mapped pose model and the first likelihood that the person is holding the weapon.

11. The method of claim 5, comprising predicting a second likelihood that the person is holding a hand-held object using at least some data from the mapped pose model and at least some data from the image; and
determining the threatening pose probability value comprises determining a threatening pose probability value using one or more of the mapped pose model, the first likelihood that the person is holding the weapon, or the second likelihood that the person is holding the hand-held object.

12. The method of claim 11, comprising computing, for at least one hand-held object category of a plurality of hand-held object categories, a hand-held object confidence score that the hand-held object is of the corresponding hand-held object category; and
wherein determining the threatening pose probability value comprises determining a threatening pose probability value using the hand-held object confidence score.

13. The method of claim 12, wherein the plurality hand-held object categories comprises at least a non-weapon category, and
in response to determining that the hand-held object confidence score is of the non-weapon category, determining the threatening pose probability value using the hand-held object confidence score of the non-weapon category.

14. The method of claim 1, wherein the plurality of pose types comprise a threatening pose type or a neutral pose type.

15. The method of claim 1, comprising:
determining, for an area in which the image that depicts the person was taken, an expected state of the area;
determining, using the expected state of the area and the first likelihood that the person is holding a weapon, whether the person is expected to be holding the weapon; and
determining, in response to determining that the person is expected to be holding the weapon, to not transmit the instructions.

16. The method of claim 1, comprising:
generating, for a second, different image that depicts the person, a second, different mapped pose model for the person that represents a second pose of the person in the second, different image;
predicting a second likelihood that the person is holding the weapon using at least some data from the second, different mapped pose model and at least some data from the second, different image;
determining, from the plurality of pose types, a second pose type for the person using the second, different mapped pose model, and
updating, in response to determining the second pose type for the person is different than the pose type, the pose type to the second pose type.

17. The method of claim 16, wherein transmitting, in response to determining the second pose type is different than the pose type, instructions to cause the device to perform the action comprises, determining whether to transmit second instructions to cause the device to perform a new action using the second pose type.

18. One or more computer storage media encoded with instructions that, when executed by one or more computers, cause the one or more computers to perform the method of claim 1.

19. A system comprising one or more computers and one or more storage devices on which are stored instructions that are operable, when executed by the one or more computers, to cause the one or more computers to perform the method of claim 1.
